(19) United States
(12) Patent Application Publication
(10) Pub. No.: US 2004/0016699 A1
(43) Pub. Date: Jan. 29, 2004

(54) Systems and methods for ultrasonic cleaning of cross-flow membrane filters

(76) Inventor: Michael Bayevsky, St. Louis Park, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/207,480

(22) Filed: Jul. 29, 2002

(51) Int. Cl. B01D 65/02; B01D 61/00; B01D 61/20

(52) U.S. Cl. 210/636; 210/650; 210/748; 210/321.69; 210/416.1

(57) ABSTRACT

This document discusses, among other things, systems and methods for ultrasonic-assisted cleaning of cross-flow membrane filters, both within and removed from a filtration system. In one example, an applied vacuum reduces a cavitation threshold, avoiding damage to certain sensitive filter membranes. In another example, the ultrasonic-assisted cleaning is used in conjunction with backflushing. In another example, different levels of ultrasound are applied to different portions of the filtration system.

### FIELD OF THE INVENTION

This document relates generally to filtration, and particularly, but not by way of limitation, to systems and methods for ultrasonic cleaning of cross-flow membrane filters.

### BACKGROUND

Cross-flow membrane technology is used in many applications, including dairy, pharmaceutical, wastewater treatment, water desalination, biotechnology, food and beverage, starch and sweeteners, and others. Such processes typically use cross-flow membrane filtration for separation and concentration. In one conceptualization, cross-flow filtration is a process in which a feed stream moves parallel to a membrane filtration surface. The cross-flow membrane filter includes a feed stream inlet, a permeate outlet, and a concentrate outlet. More particularly, during the cross-flow filtration, a purified liquid (“referred to as permeate”) passes through the porous membrane, driven by a transmembrane pressure difference from one side of the membrane to the other. Generally speaking, pore sizes typically range from between 100 molecular weights to 5 microns. The permeate is discharged through the permeate outlet of the cross-flow membrane filter. A concentrate (also referred to as a “retentate”) does not pass through the membrane, but instead continues on through the cross-flow membrane filter. The concentrate is discharged through the concentrate outlet of the cross-flow membrane filter.

One problem in cross-flow membrane filtering is fouling of the cross-flow membrane filter elements, which eventually must be replaced. This may involve considerable expense, in terms of both the replacement cost of the expensive cross-flow membrane filters, and the accompanying production downtime cost of shutting down the industrial process using the cross-flow membrane filtration system. Moreover, fouled filter elements are typically discarded in a landfill or incinerated, each of which presents adverse environmental consequences. Similarly, the use of chemical cleaning agents may also pose adverse environmental consequences. For these and other reasons, the present applicant has recognized that there is an unmet need in the art for improved systems and methods for addressing the problem presented by cross-flow membrane filter fouling.

### SUMMARY

This document discusses, among other things, systems and methods for addressing the problem presented by cross-flow membrane filter fouling. A first example of a method includes: placing a cross-flow membrane filter in an ultrasonic cleaning vessel; introducing a cleaning fluid into the vessel; applying a vacuum to the vessel to reduce a pressure in the vessel; and applying ultrasound to the filter in the vessel to assist in obtaining an at least partially cleaned filter. A second example of a method includes receiving an input liquid; cross-flow filtering the input liquid, using first and second membrane filters, to separate a permeate from a concentrate, wherein the second filter is exposed to a more concentrated concentrate than the first filter; and applying more ultrasound to the second filter than to the first filter. A third example of a method includes receiving an input liquid; cross-flow filtering the input liquid, using a filter module that includes a plurality of membrane elements, wherein the filter module includes at least one ultrasound transducer operatively coupled thereto; substantially stopping a flow through the filter module; applying ultrasound energy to the filter module during the substantially stopped flow through the filter module; and resuming the flow through the filter module after the applying the ultrasound energy is interrupted.

A first example of a system includes a vacuum-sealable cleaning vessel. The vessel is sized and shaped to receive a cross-flow membrane filter in the vessel. The vessel includes a cleaning fluid inlet to allow a cleaning fluid to enter the vessel, a cleaning fluid outlet to allow the cleaning fluid to leave the vessel, a vacuum seal, and a vacuum port. An ultrasound transducer is operatively coupled to the vessel to deliver ultrasound energy to the cleaning fluid in the vessel. A first vacuum pump is operatively coupled to the vacuum port. The first vacuum pump is configured to reduce a pressure within the vessel to reduce a cavitation threshold of the cleaning fluid such that an ultrasound energy level from the ultrasound transducer avoids damage to the filter in the vessel.

A second example of a system includes a fluid filtration system. The fluid filtration system includes an inlet, receiving an input feed stream, a permeate outlet, and a concentrate outlet. The filtration system also includes first and second cross-flow membrane filters. These filters are operatively coupled to the inlet to receive the input feed stream for separation into a permeate (directed toward the permeate outlet) and a concentrate (directed toward the concentrate outlet). In this system, the second filter is exposed to a more concentrated concentrate than the first filter. The system includes at least one ultrasound transducer, operatively coupled to at least one of the first and second filters to deliver ultrasound energy thereto. The ultrasound transducer is configured to apply more ultrasound to the second filter than to the first filter.

Other aspects of the present systems and methods will become apparent upon reading the following detailed description and viewing the drawings that form a part thereof.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic diagram illustrating generally, by way of example, but not by way of limitation, one embodiment of portions of a system for cleaning at least one cross-flow membrane filter.

FIG. 2 is a flow chart, illustrating generally, by way of example, but not by way of limitation, one embodiment of a method of cleaning a cross-flow membrane filter.

FIG. 3 is a schematic diagram illustrating generally, by way of example, but not by way of limitation, another embodiment of a system for ultrasound-assisted cross-flow membrane filter cleaning.

FIG. 4 is a cross-sectional diagram, taken along the cutline 4-4 in FIG. 3, illustrating generally, by way of example, but not by way of limitation, one embodiment of an arrangement of a vessel and ultrasound transducers.

FIG. 5 is a schematic diagram illustrating generally, by way of example, but not by way of limitation, one embodiment of another system for ultrasound-assisted cross-flow membrane filter cleaning.

FIG. 6 is a cross-sectional diagram, taken along the cutline 6-6 of FIG. 5, illustrating generally, by way of example, but not by way of limitation, one embodiment of an arrangement of a vessel and ultrasound transducers.

FIG. 7 is a schematic diagram illustrating generally, by way of example, but not by way of limitation, a cross-flow membrane filter module assembly that houses a plurality of ceramic, metallic, or tubular cross-flow membrane filter elements.

FIG. 8 is a cross-sectional schematic diagram taken along the cutline 7-7 of FIG. 7.

FIG. 9 is a flow chart illustrating generally, by way of example, but not by way of limitation, one technique for using ultrasound for assisting in in situ cleaning of filter elements in a filtration system.

FIG. 10 is a schematic diagram illustrating generally, by way of example, but not by way of limitation, one embodiment of a cross-flow membrane filtration system.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. Furthermore, all publications, patents, and patent documents referred to in this document are incorporated by reference herein in their entirety, as though individually incorporated by reference. In the event of inconsistent usages between this documents and those documents so incorporated by reference, the usage in the incorporated reference(s) should be considered supplementary to that of this document; for irreconcilable inconsistencies, the usage in this document controls.

The present systems and methods relate generally to filtration, and particularly, but not by way of limitation, to systems and methods for restorative and/or preventative ultrasonic cleaning of cross-flow membrane filters. Illustrative examples of common cross-flow membrane filtration processes include microfiltration, ultrafiltration, nanofiltration, and reverse osmosis. Microfiltration typically involves low transmembrane pressure, and membrane pore sizes between about 0.1 micron and about 12 microns. Illustrative examples of processes using microfiltration include whey and milk protein fractionation, fat removal, bacteria removal, corn syrup clarification, waste water treatment, and the like. Ultrafiltration typically involves a higher transmembrane pressure than microfiltration, and membrane pore sizes between about 20 nanometers and about 100 nanometers. Illustrative examples of processes using ultrafiltration, such as for selective separation and concentration, include whey protein concentration, waste water treatment, fruit juice clarification, milk concentration, and the like. Nanofiltration typically involves an even higher transmembrane pressure than ultrafiltration, and membrane pore sizes between about 1000 Daltons and about 5000 Daltons. Examples of processes using nanofiltration include processes in which low molecular weight solutes are retained in the concentrate channel, but salts and water are completely or partially passed through the membrane to the permeate channel. Reverse Osmosis typically involves an even higher transmembrane pressure than nanofiltration. Examples of processes using reverse osmosis include dewatering, water clarification, desalination, and the like.

Illustrative examples of different types of cross-flow membrane filters include both organic and inorganic cross-flow membrane filters. For an illustrative example, organic cross-flow membrane filters may include, among other things, a spiral-wound polymeric membrane, tubular polymeric membrane elements (a plurality of which are typically assembled in modules), hollow fiber polymeric membrane elements (a plurality of which are typically assembled in modules), plate and frame polymeric membranes, and the like. In another illustrative example, inorganic cross-flow membrane filters may include, among other things, ceramic membrane elements (a plurality of which are typically assembled in modules), metallic membrane elements (a plurality of which are typically assembled in modules), and the like.

As discussed above, the usefulness of a cross-flow membrane filtration is typically inhibited by membrane fouling. For example, in nanofiltration and reverse osmosis, membrane fouling is typically due to material in the process stream concentrating on the surface of the membrane, forming what is sometimes referred to as a polarization concentration layer. This polarization concentration layer makes it more difficult for permeate material to flow through the membrane. In another example, such as in microfiltration and ultrafiltration, membrane fouling typically occurs both on the membrane surface and also by entry of material into the membrane pores, which eventually stops flow through the clogged pores of the membrane.

Eventually all cross-flow membrane filtration processes lead to a state in which the amount of permeate that passes through the membranes falls to an unacceptable level. At that point, the filtration process will be stopped and the filtration system will be cleaned or the membrane filters will be replaced. In certain industries, filtration and cleaning form a cycle. For example, in the food and dairy industries, a filtration and cleaning cycle may be repeated every 24 hours. In one example, the cleaning is performed by circulating certain chemicals through the system, using alternating acid and caustic cycles, separated by an intervening rinsing of the filtration system. After a certain number of such filtration and cleaning cycles (e.g., for the spiral wound polymeric cross-flow membrane filtration element, usually after 6-18 months with daily cleaning) the membrane filter elements in the systems will wear out from the fouling and chemical cleaning. At that point, the filter elements need to be replaced. Membrane replacement and cleaning costs are important factors in the economic feasibility of a cross-flow membrane filtration process.

In one example, an industrial cross-flow membrane filtration system (e.g., for microfiltration, ultrafiltration, nanofiltration, or reverse osmosis) may consist of filtration modules installed in stages, with several cross-flow membrane filter elements included in each filtration module. Therefore, the total number of cross-flow membrane filter elements in a particular industrial filtration system may reach a hundred and more. Such cross-flow membrane filter elements may differ in size and nature. Commercially-available spiral wound polymeric cross-flow membrane filtration elements are available, for example, in 3.8 inch, 4.3 inch, 6 inch, 8 inch, and 10 inches in diameter, and usually about 38 inches in length. Depending on the size and type of these elements, they might cost $250 for a 3.8 inch diameter filter element, and up to $1,600 for a 10 inch diameter filter element. Such spiral-wound polymeric cross-flow membrane filter elements typically require replacement every 6-18 months. The annual replacement cost for such filters, therefore, may run into six figures per plant.

The present systems and methods include, among other things, the use of ultrasound for cleaning cross-flow membrane filters, such as to restore the filter and/or prolong the useful life of the filter. The mechanism of ultrasonic cleaning is created by the action of sound waves at high frequency (e.g., between about 20-80 KHz) introduced into a liquid medium (e.g., at an ultrasound field level ranging from about 0.3-2 Watt/cm² and up to, and even exceeding, 100 Watt/gal). The applied ultrasound creates waves of high pressure that are followed by intervening waves of lower pressure. Under certain conditions, the ultrasound level is sufficient to cause the liquid to fracture, causing a phenomenon referred to as “cavitation.” Cavitation can be conceptualized as the formation and substantially instantaneous collapse of tiny cavities, or bubbles, in the liquid. Ultrasound-induced cavitation can be used to assist in cleaning cross-flow membrane filters by dissolving and/or displacing contaminant(s). The ultrasonic energy is created in the liquid using at least one ultrasound transducer, which converts electrical energy into acoustic energy. An electrical generator circuit or the like transforms the electrical energy from the power source to the transducers, which, in one example, are installed in a cleaning vessel.

For treating cross-flow membrane filters, ultrasound-induced cavitation can also help to reduce or eliminate the polarization concentration layer in situ, for example, during the filtration process, such as either a fouling-prevention measure or a cleaning/restoration measure, or both. Ultrasonic cleaning is particularly effective on sound-reflecting materials, such as plastic and metal. The actual degree of cleaning obtained will depend on the nature of the contaminant, and will be affected by, among other things, the ultrasound frequency, the ultrasound field level needed to obtain fluid cavitation, fluid temperature, amount of dissolved gasses present in the fluid, duration of the applied ultrasound treatment, physical configuration, and the cleaning chemicals used.

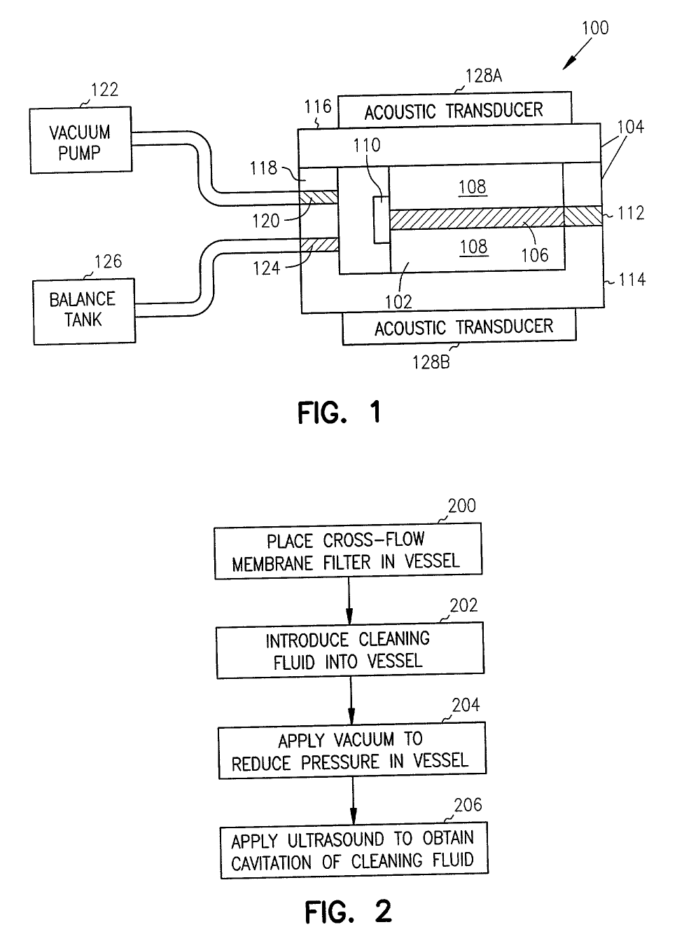

FIG. 1 is a schematic diagram illustrating generally, by way of example, but not by way of limitation, one embodiment of portions of a system 100 for cleaning at least one cross-flow membrane filter 102. In the illustrative example of FIG. 1, system 100 includes a vacuum-sealable cleaning vessel 104, which is sized and shaped to receive cross-flow membrane filter 102 within an interior cavity portion of vessel 104. In this example, cross-flow membrane filter 102 is illustrated as a fully assembled spiral-wound polymeric membrane filter, however, system 100 may be used to clean other types of cross-flow membrane filters, as well as at least partially-disassembled spiral-wound polymeric membrane filters, such as discussed further below. The illustrated cylindrical spiral-wound cross-flow membrane filter 102 includes a center permeate channel 106, extending longitudinally therethrough. In this example, permeate channel 106 is circumferentially surrounded by feed channel 108, which, during use in filtration, would receive an input feed stream at one end of cylindrical filter 102, and provide an output concentrate at the other end of the cylindrical filter 102. In the illustrated example of FIG. 1, one end of permeate channel 106 is plugged by plug 110; the other end of permeate channel 106 is operatively coupled in fluid communication with a cleaning fluid outlet port 112 in fluid communication through vessel 104.

In FIG. 1, vessel 104 includes a tank 114 and a lid 116. After the cross-flow membrane filter 102 is placed in tank 114, lid 116 is placed thereon to form a vacuum seal 118 therewith. In this example, vessel 104 includes a vacuum port 120 therethrough. Vacuum port 120 is operatively coupled to a vacuum pump 122. Vessel 104 also includes a cleaning fluid inlet port 124 therethrough. Cleaning fluid inlet port 124 is operatively coupled to a balance tank 126 or the like for receiving cleaning fluid into vessel 104 for cleaning the cross-flow membrane filter 102. The cleaning fluid may include water and/or chemical agent(s). System 100 also includes one or more acoustic transducers, such as ultrasound transducers 128A-B, disposed about the exterior or interior of vessel 104 for delivering ultrasound or other acoustic energy to at least a portion of filter 102 during the filter cleaning process. Vacuum pump 122 is configured to reduce a pressure within vessel 104 to reduce a cavitation threshold of the cleaning fluid therein. In one example, this permits use of a reduced ultrasound energy level from ultrasound transducers 128A-B, thereby avoiding damage to the cross-flow membrane filter 102 in vessel 104. The locations of vacuum port 120, cleaning fluid inlet port 124, and/or cleaning fluid outlet port 112 may vary from the locations shown in the generalized conceptual illustration of FIG. 1.

FIG. 2 is a flow chart, illustrating generally, by way of example, but not by way of limitation, one embodiment of a method of cleaning a cross-flow membrane filter, such as, for example, using the system 100 of FIG. 1. In the illustrative example of FIG. 2, at 200, a cross-flow membrane filter 102 is placed in an ultrasonic cleaning vessel 104. In one example, the cross-flow membrane filter 102 is a fully assembled spiral-wound polymeric cross-flow membrane filter. In another example, the cross-flow membrane filter 102 is a partially disassembled spiral-wound polymeric cross-flow membrane filter. In yet another example, the cross-flow membrane filter 102 a cross-flow membrane filter module including a plurality of membrane filter elements. The lid 116 of vessel 104 is then closed, or the interior portion of vessel 104 is otherwise vacuum-sealed. At 202, a cleaning fluid is introduced into the interior of vessel 104, such as from balance tank 126 through inlet 124. The cleaning fluid may include water, a chemical cleaning agent, a mixture of water and a chemical cleaning agent, and the like. Examples of suitable chemical cleaning agents include, by way of example, but not by way of limitation, caustic-based or acid-based solutions (separated by an intervening rinse), and may include sanitizing agents and/or surfactants. At 204, a vacuum is applied to the interior of vessel 104, such as by using vacuum pump 122, which is operatively coupled to vacuum port 120 in vessel 104. This reduces the pressure in the interior of vessel 104, which, in turn, reduces the cavitation threshold of the fluid, that is, the ultrasound field level required to obtain cavitation of the fluid at a particular temperature. At 206, ultrasound transducers 120A-B are activated to apply sufficient ultrasound energy to the cleaning fluid within vessel 104 to obtain cavitation of the cleaning fluid. Because vacuum has been applied to reduce the pressure in the vessel, the cavitation threshold of the cleaning fluid has been reduced, thereby lowering the ultrasound field required to obtain cavitation. This saves power. It also avoids damage to the cross-flow membrane filter during the cleaning. This is particularly advantageous, for example, for a spiral-wound polymeric cross-flow membrane filter, which is particularly susceptible to damage during ultrasonic cleaning, and which are typically limited to cleaning at temperatures that are less than or equal to about 120 or 125 degrees Fahrenheit. Applying a vacuum to reduce the pressure in the vessel and lower the cavitation threshold of the cleaning fluid will reduce or avoid damage to such a cross-flow membrane filter during the ultrasound-assisted cleaning. This may permit ultrasound-assisted filter cleaning that would not otherwise be possible because of such damage concerns. The ultrasound-assisted filter cleaning, in turn, may permit a reduction in the quantity of cleaning agents used during the filter cleaning, thereby reducing the cost and/or environmental impact of such filter cleaning.

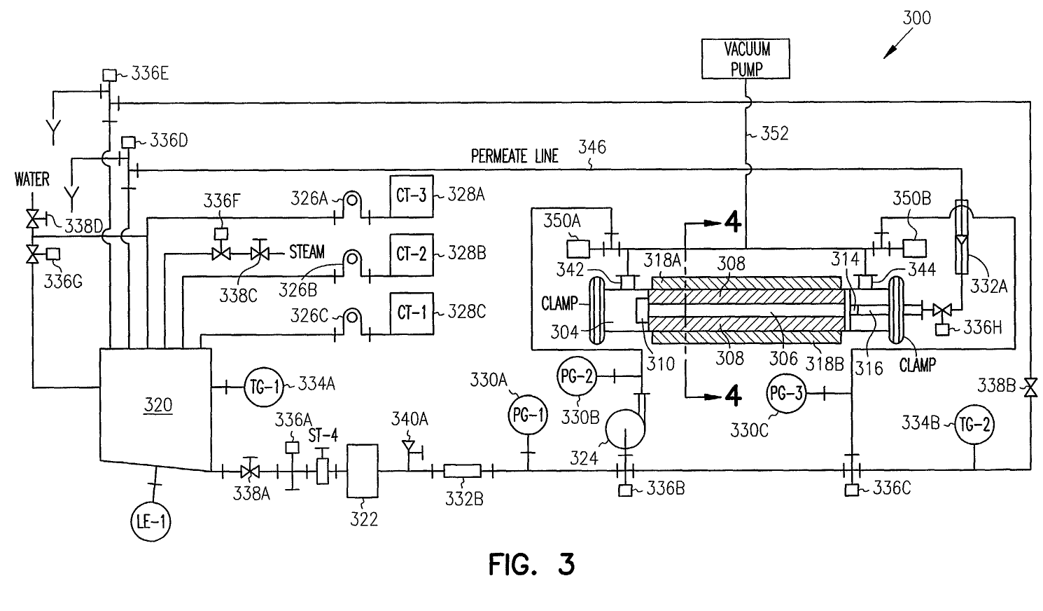

FIG. 3 is a schematic diagram illustrating generally, by way of example, but not by way of limitation, another embodiment of a system 300 for ultrasound-assisted cross-flow membrane filter cleaning. In one illustrative example, system 300 provides ultrasound-assisted cleaning of a spiral-wound polymeric cross-flow membrane filter 302, without requiring any disassembling of the spiral-wound filter 302. In the example illustrated in FIG. 3, filter 302 is removed from an industrial filtration system; by having several extra filters 302 on hand, such filters can be rotated out of the filtration system for the ultrasound-assisted cleaning, allowing the industrial filtration system to continue to operate during such cleaning (other than for swapping out one or more filters for the cleaning in vessel 304). In one example, system 300 is integrated into the main industrial filtration system. In such an example, system 300 may share a frame, utilities, control, or other components with the industrial filtration system, thereby reducing its cost.

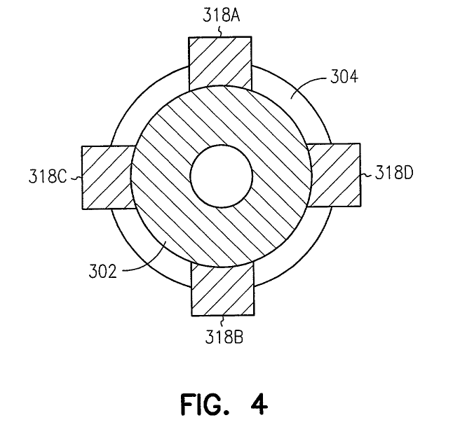

In the illustrative example of FIG. 3, system 300 includes a vacuum-sealable ultrasound-assisted cleaning vessel 304. In one example, vessel 304 is sized and shaped for receiving a cylindrical spiral-wound cross-flow membrane filter 302 fairly tightly within its interior. Spiral-wound filter 302 includes a longitudinal center permeate channel 306, circumferentially surrounded by a concentrating feed stream channel 308. In this example, permeate channel 306 is blocked at a first end by plug 310, and is operatively coupled in fluid communication to an outlet 312 by a plug 314 including a conduit 316 to outlet 312. One or more ultrasound transducers 318A-D are disposed about vessel 304 (such as by being welded thereto or otherwise placed in intimate contact therewith) for transmitting ultrasound energy to a cleaning fluid that is introduced into an interior of vessel 304. FIG. 4 is a cross-sectional diagram, taken along the cutline 4-4 in FIG. 3. FIG. 4 illustrates generally, by way of example, but not by way of limitation, one embodiment of an arrangement of ultrasound transducers 318A-D about vessel 304.

The illustrative example of FIG. 3 also includes a balance tank 320, a feed pump 322, a recirculation pump 324, one or more chemical pumps 326A-C (such as for introducing cleaning agent(s) and the like from corresponding chemical tanks 328A-C into balance tank 320), pressure gauges 330A-C, flow gauges 332A-B, temperature gauges 334A-B, automatic valves 336A-H, manual valves 338A-D, divert valves 350A-B, and one or more pressure relief valves 340. A cleaning fluid inlet 342 of vessel 302 allows cleaning fluid to be introduced into vessel 302. In this example, the cleaning fluid is pumped through the concentrating feed stream channel of spiral-wound cross-flow membrane filter 302, and recirculated back through cleaning fluid inlet 342 through cleaning fluid outlet 344, divert valve 350B, valves 336C and 336B, recirculation pump 324, and divert valve 350A. A resulting permeate obtained during the cleaning process is removed from vessel 304, via outlet 312, using fluid-communicative permeate line 346.

Cleaning fluid is initially or additionally introduced into vessel 304, from balance tank 320, by feed pump 322, such as through valves 338A, 336A, 340A, 336B, and flow gauge 332B. In one example, feed pump 322 includes a high pressure positive displacement pump, such as for reverse osmosis or nanofiltration filters 302 being cleaned, or a centrifugal pump, such as for microfiltration or ultrafiltration filters 302 being cleaned. In one example, balance tank 320 is initially filled with water, and cleaning agents or other chemicals are added thereto using one or more of pumps 326A-C. The temperature of the fluid within balance tank 320 is heated or otherwise adjusted as appropriate for the cleaning process. The resulting solution is introduced into vessel 304, and recirculated therethrough.

Before applying ultrasound, the pressure within the interior of vessel 304 is reduced, by applying a vacuum, to reduce the cavitation threshold of the cleaning fluid therein. In the example illustrated in FIG. 3, system 300 includes divert valves 350A-B. Divert valves 350A-B respectively switch inlet 342 and outlet 344 between (a) being in fluid communication with a vacuum line 352, and (b) being in fluid communication with the above-described cleaning fluid recirculation path through recirculation pump 324. For applying the vacuum to reduce the cavitation threshold of the cleaning fluid, divert valves 350A-B switch inlet 342 and outlet 344 to be in fluid communication with vacuum line 352, which is connected to vacuum pump 354. Vacuum pump 354 is then activated to apply the vacuum to the interior of vessel 304 for reducing the cavitation threshold of the cleaning fluid therein. With divert valves 350A-B in this position, ultrasound is then applied, as described below, to assist in the filter cleaning. Then, divert valves 350A-B are switched to recirculate the cleaning fluid through the vessel, as described above, to also assist in the filter cleaning.

During the application of the ultrasound, transducers 318A-B provide an ultrasonic field that is sufficient to induce cavitation of the cleaning fluid within vessel 304 at its particular temperature (typically less than 125 degrees Fahrenheit, for a spiral-wound polymeric cross-flow membrane filter 302). The ultrasound-induced cavitation assists in at least partially cleaning and/or restoring the filter 302. In one example, recirculation of the fluid through vessel 304 is interrupted during the application of the ultrasound treatment, and resumed thereafter (such as by using the divert valves 350A-B discussed above). In another example, application of the ultrasound is followed by backflushing the filter 302, such as where filter 302 is sufficiently rugged to withstand such backflushing, as with a ceramic membrane filter element.

In another example, it may be desirable to at least partially disassemble a cross-flow membrane filter element before cleaning. For example, it may be more difficult for ultrasound to penetrate into the center of the more expensive larger diameter (e.g., greater than 8 inches) spiral-wound cross-flow membrane filter for inducing cavitation in the cleaning fluid therein. By at least partially disassembling such a spiral-wound cross-flow membrane filter, additional cleaning fluid flow and/or a higher ultrasound energy field may be obtained near the center portion of the filter. Such at least partial disassembly may also obtain similar benefits even for smaller diameter spiral-wound cross-flow membrane filters. In one example, the at least partial disassembly is performed by carefully cutting a plastic outer retaining wrap around the spiral-wound membrane. Re-assembly is performed by carefully re-wrapping a new such plastic outer retaining wrap around the spiral-wound membrane. As discussed further below, in one embodiment, a vacuum is applied to the at least partially disassembled spiral-wound cross-flow filter element, to assist in compacting the spiral-wound membrane, before re-assembly by re-wrapping the spiral-wound membrane.

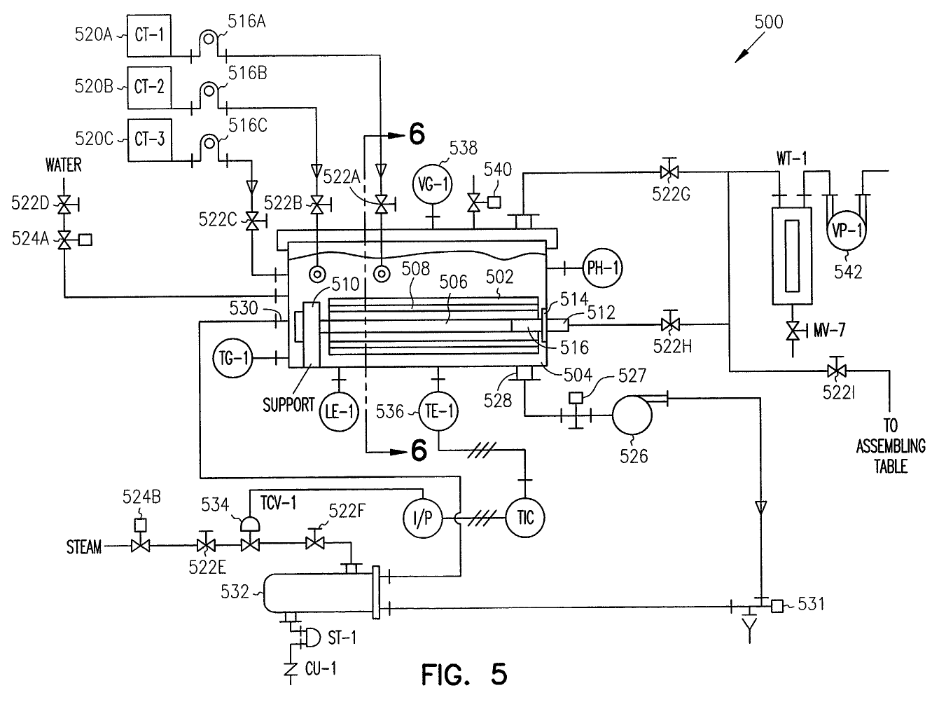

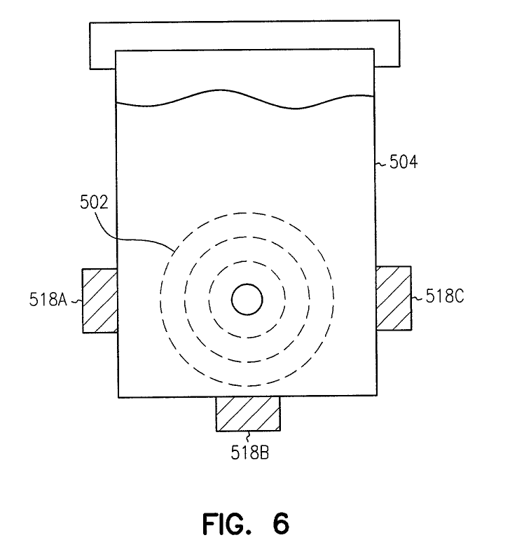

FIG. 5 is a schematic diagram illustrating generally, by way of example, but not by way of limitation, one embodiment of another system 500 for ultrasound-assisted cross-flow membrane cleaning. In this illustrative example, system 500 is designed to accommodate ultrasound-assisted cleaning of an at least partially disassembled spiral-wound cross-flow filter element 502. However, system 500 can also be used to perform ultrasound cleaning of a fully-assembled spiral-wound filter element. In the illustrative example of FIG. 5, system 500 includes a vacuum-sealable ultrasound-assisted cleaning vessel 504, which, in one example, is sized and shaped for receiving an at least partially disassembled cylindrically-shaped spiral-wound cross-flow membrane filter 502 fairly loosely within its interior. Spiral-wound filter 502 includes a longitudinal center permeate channel 506, circumferentially surrounded by an at least partially disassembled concentrating feed stream channel 508. In this example, permeate channel 506 is blocked at a first end by plug 510, and is operatively coupled in fluid communication to an outlet 512 by a plug 514 including a conduit 516 to outlet 512. One or more ultrasound transducers 518A-C is disposed about vessel 504 (such as by being welded thereto or otherwise placed in intimate contact therewith) for transmitting ultrasound energy to a cleaning fluid that is introduced into an interior of vessel 504. FIG. 6 is a cross-sectional diagram, taken along the cutline 6-6 of FIG. 5. FIG. 6 illustrates generally, by way of example, but not by way of limitation, one embodiment of an arrangement of vessel 504 and ultrasound transducers 518A-C.

In the illustrative example of FIG. 5, one or more chemical pumps 518A-C introduce cleaning agent(s) and the like from respective chemical tanks 520A-C through inlets into vessel 504, such as through respective manual valves 522A-C. Such cleaning agent(s) may be mixed with water introduced through an inlet into vessel 504, such as through manual valve 522D and automatic valve 524A. This cleaning solution within vessel 504 is recirculated therethrough by recirculation pump 526, which is coupled through automatic valve 527 to inlet 528 of vessel 504, and to outlet 530 of vessel 504 through automatic valve 531 and heat exchanger 532, which heats the cleaning fluid to a desired operating temperature for performing the cleaning. In this example, heat exchanger 532 receives steam heat through automatic valve 524B, manual valves 522E and 522F, and temperature control valve 534, which is controlled by feedback from a temperature gauge 536 measuring the temperature of the cleaning fluid within vessel 504. Vessel 504 also includes a vacuum gauge 538 and a vacuum relief valve 540.

In the illustrative example of FIG. 5, a vacuum pump 542 is operatively coupled to a vacuum port 544 of vessel 504, such as through manual valve 522G, for degassing the cleaning fluid in vessel 504, and for reducing a pressure within vessel 504 to reduce a cavitation threshold of the cleaning fluid therein. In one example, vacuum pump 542 is also operatively coupled to outlet 512 of vessel 504, such as through manual valve 522H, for drawing cleaning fluid out from permeate channel 506 of filter 502. In a further example, vacuum pump 542 is also operatively coupled (such as through manual valve 5221) to a fixture on an assembling table, into which the at least partially disassembled spiral-wound filter 502 is placed, for drawing together the spiral-wound membrane element before rewrapping the spiral-wound membrane filter 502 to reassemble it.

In one example, at least partially disassembled filter elements are individually placed in vessel 504 for being cleaned individually. One end of the permeate tube 506 of the filter 502 is connected, through outlet 512, to vacuum pump 542; the other end of permeate tube 506 is plugged by plug 510, which also supports the at least partially disassembled filter 502. The vessel 504 is filled with soft water to cover the filter 502, and any desired chemical agent(s) are added. Recirculation pump 504 (e.g., a centrifugal pump, or the like) starts providing gentle flow of the cleaning fluid through vessel 504. Air pockets in the filter element 502 can be removed by manually moving leaves of the element. A vacuum-sealing lid portion of vessel 504 is then secured to obtain a vacuum tight seal (e.g., using a gasket). The temperature of the cleaning fluid is adjusted, the vacuum is applied to reduce the pressure within vessel 504 to reduce the cavitation threshold of the cleaning fluid therein. Ultrasound is then applied, using transducers 518A-C, to assist in cleaning the filter 502.

In the example illustrated in FIG. 5, vacuum is used to lower the cavitation threshold of the cleaning fluid therein, decreasing the ultrasonic field level needed to obtain cavitation. This in turn reduces energy consumption as well as reduces the risk of damaging the cross-flow membrane filter 502, which is particularly advantageous for spiral-wound polymeric cross-flow membrane filters 502 and the like that are not as rugged as other cross-flow membrane filter elements. In the example of FIG. 5, vacuum may also be used to degas the water or cleaning solution in the vessel 504. Moreover, vacuum may also be used to provide some flow through the permeate channel (e.g., by applying a vacuum to outlet 512, which is in fluid communication with permeate channel 506 of filter 502) to improve the cleaning of contaminants clogging the membrane pores; this is particularly advantageous for microfiltration and ultrafiltration filters 502. (In one example, vacuum above the liquid level in vessel 504 is relieved after ultrasound is applied, and only then is vacuum applied to permeate channel 506 for flow promotion; the cavitation threshold-lowering vacuum and the permeate flow promoting vacuum are not used together, in this example). Furthermore, vacuum may also be used to draw together the spiral-wound membrane during re-assembly (such as after removal from the vessel 504) so that it can be more tightly wrapped with a retaining wrap. In one example, the new wrap is sealed in place using a hot bar.

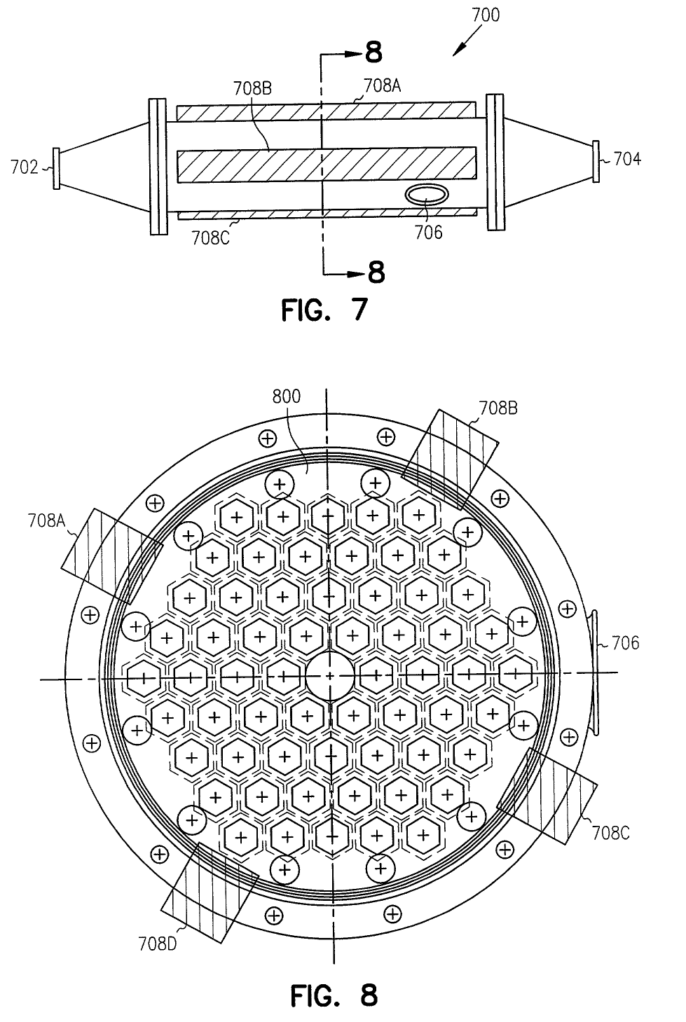

FIG. 7 is a schematic diagram illustrating generally, by way of example, but not by way of limitation, a cross-flow membrane filter module assembly 700 that houses a plurality of ceramic, metallic, or tubular cross-flow membrane filter elements 800. FIG. 8 is a cross-sectional schematic diagram taken along the cutline 7-7 of FIG. 7. In the example of FIGS. 7 and 8, filter module assembly 700 includes a feed stream inlet 702, a concentrated feed stream outlet 704, a permeate outlet 706, and one or more ultrasound transducers 708A-D disposed about module assembly 700, such as by welding or otherwise affixing thereto. In contrast to spiral-wound polymeric cross-flow filter elements, the more rugged ceramic, metallic, or tubular cross-flow membrane filter elements can tolerate backflow through the permeate channel 706, thereby allowing cleaning of the filter module assembly 700 backflushing. The backflushing of a filtration system using one or more such filter module assemblies 700 is carried out in situ occasionally to send permeate backward at certain intervals. This assists in reducing or eliminating the polarization concentration layer on the surface of the cross-flow membrane filter elements 800 to enhance their subsequent filtration performance. In the examples of FIGS. 7 and 8, ultrasound transducers 708A-D are activated to provide an ultrasound field within the fluid being filtered by cross-flow membrane filter assembly 700 so as to induce cavitation therein. This assists in cleaning the filter elements 800.

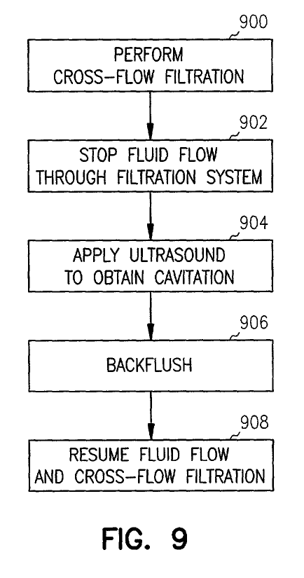

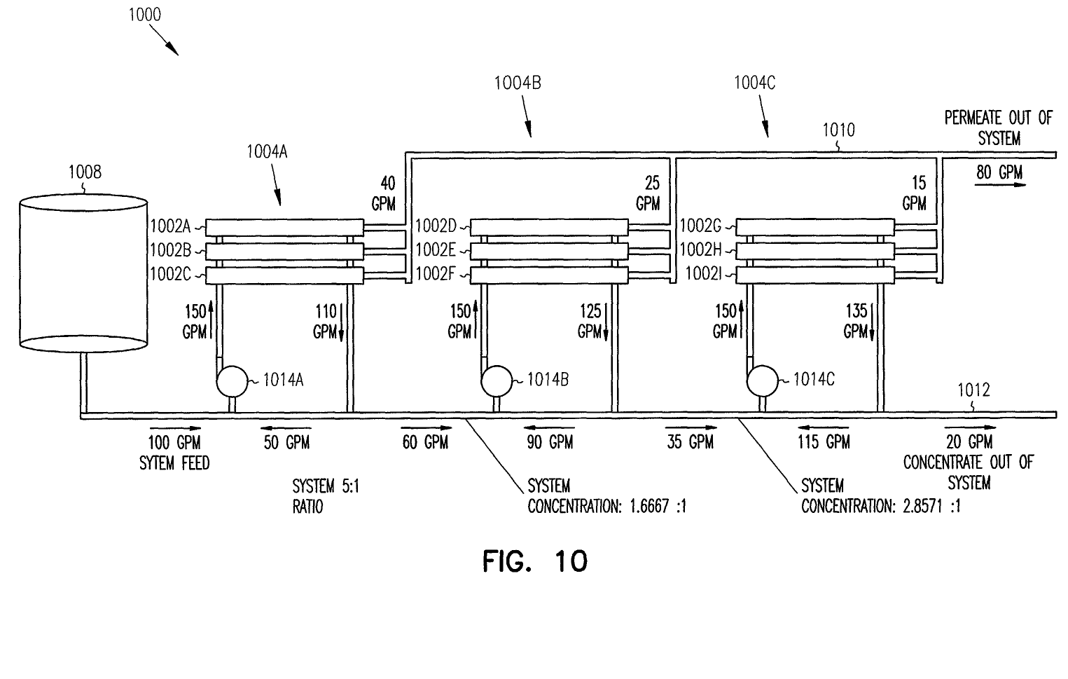

FIG. 9 is a flow chart illustrating generally, by way of example, but not by way of limitation, one technique for using ultrasound for assisting in in situ cleaning of filter elements 800 in a filtration system. In this example, at 900, cross-flow filtration of a feed stream is being performed by a cross-flow membrane filtration system. At 902, the fluid flow through the filtration system is stopped. At 904, ultrasound energy is applied to obtain cavitation of the fluid within one or more of the cross-flow membrane filter module assemblies 700. At 906, backflushing of the permeate channel is performed on that one or more cross-flow membrane filter module assemblies 700 to which the ultrasound was applied. (Backflushing can also be performed on other filter module assemblies 700 to which ultrasound was not applied). At 908, fluid flow through the filtration system is resumed, thereby resuming the cross-flow filtration of the fluid passing therethrough.

FIG. 10 is a schematic diagram illustrating generally, by way of example, but not by way of limitation, one embodiment of a cross-flow membrane filtration system 1000. In this example, filtration system includes a plurality of cross-flow membrane filter module assemblies 1002A-I, arranged in serial stages 1004A-C. Filtration system 1000 includes a system feed conduit 1006, operatively coupled in fluid communication with a system feed tank 1008. Filtration system 1000 also includes an output permeate conduit 1010 and an output concentrate conduit 1012. Exemplary flow rates have been included on FIG. 10 (for illustrative purposes only, and not by way of limitation). A flow of 100 gallons per minute exists at system feed 1006.

Using pump 1014A, first stage 1004A circulates 150 gallons per minute through its cross-flow membrane filter assemblies 1002A-C. Of this, 110 gallons per minute are returned back to the concentrate conduit 1012, and 40 gallons per minute are removed to the permeate conduit 1010. Of this returned 110 gallons per minute to concentrate conduit 1012, 50 gallons per minute are recirculated back through first stage 1004A; 60 gallons per minute are passed forward to second stage 1004B.

Using pump 1014B, second stage 1004B circulates 150 gallons per minute through its cross-flow membrane filter assemblies 1002D-F. Of this, 125 gallons per minute are returned back to the concentrate conduit 1012, and 25 gallons per minute are removed to the permeate conduit 1010. Of this returned 125 gallons per minute to concentrate conduit 1012, 90 gallons per minute are recirculated back through second stage 1004B; 35 gallons per minute are passed forward to third stage 1004C.

Using pump 1014C, third stage 1004C circulates 1150 gallons per minute through its cross-flow membrane filter assemblies 1002G-10021. Of this, 135 gallons per minute are returned back to the concentrate conduit 1012, and 15 gallons per minute are removed to the permeate conduit 1010. Of this returned 135 gallons per minute to concentrate conduit 1012, 115 gallons per minute are recirculated back through third stage 1004C; 20 gallons per minute are passed forward as output from concentrate conduit 1012. Permeate conduit 1010 outputs 80 gallons per minute, which is the sum of the individual permeate outputs of the three stages 1004A-C.

This example illustrates that not all cross-flow membrane filter assemblies 1002A-I are performing under equal conditions. For example, third stage 1004C is performing its filtration at higher concentration levels than that of first stage 1004A and second stage 1004B. Thus, third stage 1004C is subject to more fouling problems than second stage 1004B; similarly, second stage 1004B is subject to more fouling problems than first stage 1004A. In one embodiment, the present systems and methods address this problem by applying, in situ, a greater degree of ultrasound to portions of a filtration system that are more prone to fouling than to other portions of the filtration system that are less prone to fouling. This tends to equalize system performance, so that the filtration system can be run longer between cleanings. It also reduces system cost, since it does not require that ultrasound be applied to every cross-flow membrane filter assembly 1002A-I in the filtration system. As an illustrative example, ultrasound transducers might be installed only on the third stage 1004C of the filtration system 1000 illustrated in FIG. 10, because third stage 1004C sees the most concentrated product and therefore is subject to the most fouling. This also benefits less critical portions of the filtration system 1000, such as first stage 1004A and second stage 1004B, because a fouled portion of system 1000 will effectively shift load to the other portions of the system. In the example of FIG. 10, the ultrasound-assisted cleaning can be performed in situ, for example, as discussed above with respect to FIGS. 8 and 9. In another example, the ultrasound-assisted cleaning can be performed by rotating more fouling-prone filter module assemblies 1002G-I out for cleaning in an external vessel more frequently than less fouling-prone filter module assemblies 1002A-C or 1002D-F.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

What is claimed is:

1. A method including:
placing a cross-flow membrane filter in an ultrasonic cleaning vessel;
introducing a cleaning fluid into the vessel;
applying a vacuum to the vessel to reduce a pressure in the vessel; and
applying ultrasound to the filter in the vessel to assist in obtaining an at least partially cleaned filter.

2. The method of claim 1, in which the applying the vacuum to the vessel includes applying the vacuum at a level to reduce the pressure in the vessel by an amount sufficient to lower a cavitation threshold of the fluid.

3. The method of claim 2, in which the applying the vacuum to the vessel includes applying the vacuum at a level to reduce the pressure in the vessel by an amount sufficient to lower a cavitation threshold of the fluid in the presence of an applied ultrasound field value that substantially avoids damage to the membrane filter.

4. The method of claim 1, in which the applying ultrasound includes applying ultrasound, to induce cavitation of the fluid, at an first ultrasound level that is lower than a second ultrasound level that obtains cavitation of the fluid in the absence of the applying the vacuum to the vessel to reduce the pressure in the vessel.

5. The method of claim 1, in which the applying ultrasound to the filter includes applying ultrasound to a polymeric spiral-wound cross-flow membrane filter.

6. The method of claim 1, further including applying a vacuum to the vessel during a degassing of the fluid in the vessel.

7. The method of claim 1, further including applying a vacuum to a permeate channel of the filter in the vessel to induce flow of the fluid in the permeate channel of the filter in the vessel.

8. The method of claim 1, in which the placing the cross-flow membrane filter in the vessel includes placing an at least partially disassembled spiral-wound filter in the vessel.

9. The method of claim 8, further including applying a vacuum to a permeate channel of the at least partially disassembled filter in the vessel to induce flow of the fluid in the at least partially disassembled permeate channel of the filter in the vessel, wherein the vacuum is applied at a level to induce the flow at a flow rate that is less than a flow rate through the filter when assembled and operatively filtering in a cross-flow filtration system.

10. The method of claim 8, further including reassembling the at least partially disassembled spiral-wound filter.

11. The method of claim 10, in which the reassembling includes applying a vacuum to the at least partially disassembled spiral-wound filter.

12. The method of claim 1, further including rotating the at least partially cleaned filter back into the same filtration system that fouled the filter.

13. The method of claim 1, further including using at least a portion of the at least partially cleaned filter in a second filtration system that is different from a first filtration system that fouled the filter, in which the second filtration system has at least one less stringent filtration requirement than the first filtration system.

14. A method including:
receiving an input liquid;
cross-flow filtering the input liquid, using first and second membrane filters, to separate a permeate from a concentrate, wherein the second filter is exposed to a more concentrated concentrate than the first filter; and
applying more ultrasound to the second filter than to the first filter.

15. The method of claim 14, in which the cross-flow filtering includes filtering using serial first and second stages that respectively include the first and second filters, and further including removing permeate between the first and second stages.

16. A method including:
receiving an input liquid;
cross-flow filtering the input liquid, using a filter module that includes a plurality of membrane elements, wherein the filter module includes at least one ultrasound transducer operatively coupled thereto;
substantially stopping a flow through the filter module;
applying ultrasound energy to the filter module during the substantially stopped flow through the filter module; and
resuming the flow through the filter module after the applying the ultrasound energy is interrupted.

17. The method of claim 16, further including backflushing the filter module after the applying the ultrasound energy to the filter module.

18. The method of claim 17, in which the backflushing is carried out before the resuming the flow through the filter module.

19. A system including:
a vacuum-sealable cleaning vessel, sized and shaped to receive a cross-flow membrane filter in the vessel, the vessel including:
a cleaning fluid inlet to allow a cleaning fluid to enter the vessel;
a cleaning fluid outlet to allow the cleaning fluid to leave the vessel;
a vacuum seal; and
a vacuum port;
an ultrasound transducer, operatively coupled to the vessel to deliver ultrasound energy to the cleaning fluid in the vessel; and
a first vacuum pump, operatively coupled to the vacuum port, the first vacuum pump configured to reduce a pressure within the vessel to reduce a cavitation threshold of the cleaning fluid such that an ultrasound energy level from the ultrasound transducer avoids damage to the filter in the vessel.

20. The system of claim 19, further including a second vacuum pump that is operatively coupled to the cleaning fluid outlet to draw cleaning fluid out of the vessel through a permeate channel of the filter.

21. The system of claim 20, in which the first vacuum pump and the second vacuum pump are configured as a single vacuum pump that is operatively coupled to both the vacuum port and the cleaning fluid outlet.

22. The system of claim 19, in which the first vacuum pump is operatively coupled to the vacuum port to reduce a pressure within the vessel to degas the cleaning fluid before ultrasound energy is delivered to the cleaning fluid.

23. The system of claim 19, in which the vessel is sized and shaped to receive an at least partially disassembled spiral-wound cross-flow membrane filter in the vessel.

24. The system of claim 23, in which the first vacuum pump is operatively coupled to a permeate channel of the at least partially disassembled spiral-wound cross-flow membrane filter to reduce a pressure within the at least partially disassembled spiral-wound cross-flow membrane filter by an amount sufficient to assist in reassembling the at least partially disassembled spiral-wound cross-flow membrane filter.

25. The system of claim 19, in which the vessel is sized and shaped to receive an assembled spiral-wound cross-flow membrane filter in the vessel.

26. The system of claim 19, further including:
a vacuum-relief valve, operatively coupled to the vessel;
a pressure gauge, operatively coupled to an interior of the vessel;
a temperature gauge, operatively coupled to the interior of the vessel; and
a temperature control element, operatively coupled to the interior of the vessel to control a temperature of the cleaning fluid.

27. A fluid filtration system including:
an inlet receiving an input feed stream;
a permeate outlet;
a concentrate outlet;
first and second cross-flow membrane filters, operatively coupled to the inlet to receive the input feed stream for separation into a permeate, directed toward the permeate outlet, and a concentrate, directed toward the concentrate outlet, wherein the second filter is exposed to a more concentrated concentrate than the first filter; and
at least one ultrasound transducer, operatively coupled to at least one of the first and second filters to deliver ultrasound energy thereto, the ultrasound transducer configured to apply more ultrasound to the second filter than to the first filter.

28. The system of claim 27, further including a permeate-removal conduit, located between the first and second filters, to remove permeate separated by the first filter such that the second filter is exposed to the more concentrated concentrate than the first filter.
